(19) United States
(12) Patent Application Publication
(10) Pub. No.: US 2015/0234558 A1
(43) Pub. Date: Aug. 20, 2015

(54) INFORMATION PROCESSING APPARATUS AND METHOD, INFORMATION PROCESSING SYSTEM, AND PROGRAM

(71) Applicant: Sony Corporation, Minato-ku (JP)

(72) Inventors: Hirotake ICHIKAWA, Tokyo (JP); Tsuyoshi Ishikawa, Kanagawa (JP)

(73) Assignee: Sony Corporation, Minato-ku (JP)

(21) Appl. No.: 14/594,424

(22) Filed: Jan. 12, 2015

(30) Foreign Application Priority Data
Feb. 18, 2014 (JP) 2014-028065

(51) Int. Cl. G06F 3/0484; G06F 3/0481

(52) U.S. Cl. CPC G06F 3/0484; G06F 3/0481

(57) ABSTRACT

There is provided an information processing apparatus including a display section which displays a window for each content including an application program used for each user, a user recognition section which individually recognizes users browsing the display section, and a window management section which, at the time when one of the users performs a log out, stores a layout displayed by the display section of a window group used by the user, and at the time when the user performs a log in, causes the window group used by the user to be displayed on the display section by restoring the layout.

### CROSS REFERENCE TO RELATED APPLICATIONS

This application claims the benefit of Japanese Priority Patent Application JP 2014028065 filed Feb. 18, 2014, the entire contents of which are incorporated herein by reference.

### BACKGROUND

The present disclosure relates to an information processing apparatus and method, an information processing system and a program, and specifically relates to an information processing apparatus and method, an information processing system and a program which can reproduce a layout of windows prior to performing a log out at the time of performing a log in. In large screen devices such as those including a touch panel, which are expected to spread from now onwards, there is the feature of a distance or position of a user who is an operator significantly changing, in comparison to that of a television receiver (TV) and a personal computer (PC). Accordingly, technology has been proposed which implements an optimum layout in accordance with a distance and position relation system between a user and a screen.

For example, technology has been proposed which uses position information as an input, and performs an adjustment of a window layout by using a recognition result of a user (refer to JP 2009-087026A).

Further, a system has been proposed which follows a front position of a user, causes windows to be moved, and adjusts a window size according to a distance between a screen and the user (refer to JP 2010-026327A).

### SUMMARY

Incidentally, both of the technologies of JP 2009-087026A and JP 2010-026327A relate to an adjustment of a display while a user is logged in.

However, since the preservation of the layout of windows, at the timing immediately prior to performing a log out, is not considered in JP 2009-087026A and JP 2010-026327A, when performing a log out once and then performing a log in again, the layout of windows will be set to an initial state, and so it may be necessary for a user to store the layout of windows by himself or herself, and to perform restoration when newly performing a log in, in order to restore the browsing state prior to performing a log out.

Further, in the case where a device which newly performs a log in is different to that used when performing a log out, since the same arrangement is not able to be performed, even if attempting to use the layout at the time of performing a log out, restoration will be difficult.

The present disclosure is performed by considering such a situation, and specifically can reproduce a layout of windows prior to performing a log out at the time of performing a log in.

According to an embodiment of the present disclosure, there is provided an information processing apparatus including a display section which displays a window for each content including an application program used for each user, a user recognition section which individually recognizes users browsing the display section, and a window management section which, at the time when one of the users performs a log out, stores a layout displayed by the display section of a window group used by the user, and at the time when the user performs a log in, causes the window group used by the user to be displayed on the display section by restoring the layout.

The window management section may include a visual field range specification section which specifies a visual field range on the display section of the user. The window management section, at the time when the user performs a log out, may store a layout displayed on the display section of a window group in a visual field range of the user, and at the time when the user performs a log in, may cause windows used by the user to be displayed by restoring the layout in the visual field range of the user.

The window management section may include a coordinate calculation section which calculates relative coordinates expressed by a coordinate system set in the visual field range based on actual coordinates of a window group on the display section, or calculates the actual coordinates of a window group on the display section based on the relative coordinates and the visual field range. The window management section, at the time when the user performs a log out, may cause layout data including the relative coordinates corresponding to actual coordinates of a layout displayed on the display section of the window group in a visual field range of the user to be stored, and at the time when the user performs a log in, may read the layout data, and causes a window group used by the user to be displayed with the actual coordinates, corresponding to the relative coordinates and the visual field range, by restoring the layout in the visual field range of the user.

The information processing apparatus may further include a layout data storage section which stores the layout data. The window management section, when a log out is performed, may cause the layout data to be stored in the layout data storage section together with information identifying the user, and at the time when a log in is performed, may read the layout data from the layout data storage section.

The layout data storage section may be provided in a server capable of communicating via a network. At the time when the user performs a log out, the window management section may cause the layout data to be stored in the layout data storage section of the server, and at the time when the user performs a log in, the window management section may read the layout data from the server, and causes windows used by the user to be displayed on the display section by restoring the layout data.

The information processing apparatus may further include a priority score setting section which sets a priority score for each of the windows in the window group. In the case where an information processing apparatus to which the user has performed a log out and an information processing apparatus to which the user has performed a log in are different, the window management section, at the time when all the windows for restoring the layout are not able to de displayed, may cause part of the windows to be displayed on the display section in accordance with the priority score.

The priority score setting section may set a priority score in accordance with all, or a combination, of an operation history, a display size, and a frequency at which a visual line of the user turns toward, for each of the windows in the window group.

In the case where an information processing apparatus to which the user has performed a log out and an information processing apparatus to which the user has performed a log in are different, the window management section may set a suitable size of windows in accordance with a resolution and size of the display section of the information processing apparatus to which a log in is performed, and at the time when a size of the windows for restoring the layout is larger or smaller than a suitable size, causes the windows to be displayed on the display section by setting to the suitable size.

According to another embodiment of the present disclosure, there is provided an information processing method including displaying, by a display section, a window for each content including an application program used for each user, individually recognizing users browsing the display section, and storing, at the time when one of the users performs a log out, a layout displayed by the display section of a window group used by the user, and at the time when the user performs a log in, causing the window group used by the user to be displayed on the display section by restoring the layout.

According to still another embodiment of the present disclosure, there is provided a program for causing a computer to execute the processes of displaying, by a display section, a window for each content including an application program used for each user, individually recognizing users browsing the display section, and storing, at the time when one of the users performs a log out, a layout displayed by the display section of a window group used by the user, and at the time when the user performs a log in, causing the window group used by the user to be displayed on the display section by restoring the layout.

According to an embodiment of the present disclosure, there is provided an information processing system including an information processing apparatus, and a server. The information processing apparatus includes a display section which displays a window for each content including an application program used for each user, a user recognition section which individually recognizes users browsing the display section, and a window management section which, at the time when one of the users performs a log out, transmits layout data which is data of a layout displayed by the display section of a window group used by the user to the server, and at the time when the user performs a log in, receives the layout data from the server, and causes the window group used by the user to be displayed on the display section by restoring the layout. The server includes a storage section which stores the layout data, and a communication section which receives the layout data from the information processing apparatus, and transmits the layout data stored in the storage section to the information processing apparatus.

According to an embodiment of the present disclosure, by a display section, a window for each content including an application program used for each user may be displayed, users browsing the display section are individually recognized, and at the time when one of the users performs a log out, a layout displayed by the display section of a window group used by the user is stored, and at the time when the user performs a log in, the window group used by the user is caused to be displayed on the display section by restoring the layout.

According to an embodiment of the present disclosure, it becomes possible to reproduce and display a layout of windows prior to performing a log out at the time of performing a log in.

### BRIEF DESCRIPTION OF THE DRAWINGS

FIG. 1 is a block diagram which describes a configuration of an embodiment of an information processing apparatus applicable to the present disclosure;

FIG. 2 is a flow chart which describes a log out time process by the information processing apparatus of FIG. 1;

FIG. 3 is a figure which describes a visual field range;

FIG. 4 is a figure which describes a relation between actual coordinates and relative coordinates;

FIG. 5 is a flow chart which describes a log in time process by the information processing apparatus of FIG. 1;

FIG. 6 is a figure which describes processes at the time of performing a log out and at the time of performing a log in;

FIG. 7 is a figure which describes another relation between actual coordinates and relative coordinates;

FIG. 8 is a figure which describes another relation between actual coordinates and relative coordinates;

FIG. 9 is a block diagram which describes a configuration of an embodiment of an information processing system applicable to the present disclosure;

FIG. 10 is a flow chart which describes a log out time process by the information processing system of FIG. 9;

FIG. 11 is a flow chart which describes a log in time process by the information processing system of FIG. 9;

FIG. 12 is a figure which describes a restoration example of a layout of a window group at the time of performing a log in;

FIG. 13 is a figure which describes another example for a restoration example of a layout of a window group at the time of performing a log in; and

FIG. 14 is a figure which describes a configuration example of a general-purpose personal computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the modes (hereinafter, called embodiments) for implementing the present disclosure will he described. A description will be made in the following order.

1. First embodiment (case of only an information processing apparatus)

2. Second embodiment (case of an information processing system including an information processing apparatus and a server)

### 1. First Embodiment

### <Configuration Example of the Information Processing Apparatus>

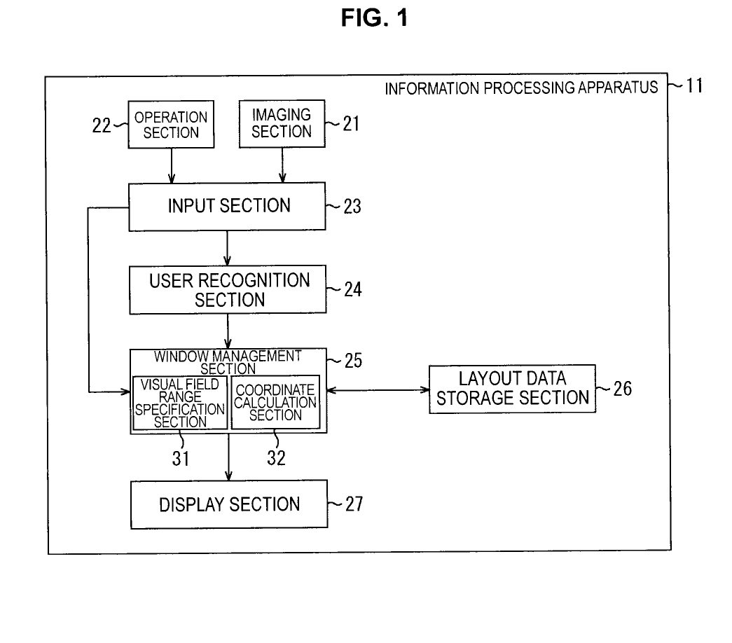

FIG. 1 is a block diagram which shows a configuration example of an embodiment of an information processing apparatus applicable to the present disclosure.

The information processing apparatus 11 of FIG. 1 includes an operation section 21 and a display section 27 constituted from a large-sized touch panel, and can individually execute and display content constituting an application program, by having a plurality of users perform a log in or a log out. Further, the information processing apparatus 11 displays an execution result for each content by respective window units. In addition, the information processing apparatus 11 stores information of a layout of windows in a visual field range of a user immediately prior to when the user performs a log out, and restores and displays the layout in accordance with the visual field range of the user at the time when a log in is performed after this.

More specifically, the information processing apparatus 11 includes an imaging section 21, an operation section 22, an input section 23, a user recognition section 24, a window management section 25, a layout data storage section 26, and a display section 27.

The imaging section 21 is constituted from a Charge Coupled Device (CCD), a Complementary Metal Oxide Semiconductor (CMOS) or the like. The imaging section 21 captures an image of a range in which users are present, who are browsing the windows of each content displayed on the display section 27 which is constituted from a Liquid Crystal Display (LCD), an organic Electro Luminescence (EL) or the like of the information processing apparatus 11, or who are inputting tap operations or the like to these windows, and supplies the captured image to the input section 23.

The operation section 22 is constituted from a touch panel or the like included on the display section 27, receives an operation input of a user, generates operation signals corresponding to the operation content, and outputs the generated operation signals to the input section 23 together with information of an operation position on the display section 27. Further, in the case where operation buttons, a keyboard or the like are additionally included, and operations are performed by these, the operation section 22 outputs operation signals corresponding to the operation content to the input section 23 together with information of the positions at which the operation buttons and keyboard are arranged.

The input section 23 receives the image supplied by the imaging section 21 and an input of information of the operation signals and operation position supplied by the operation section 22, outputs information of the image to the user recognition section 24, and supplies the information of the operation signals and operation position to the window management section 25.

The user recognition section 24 extracts facial images of the users captured within the image supplied by the input section 23, and generates information which shows the browsing positions of the present users with respect to the display section 27 from position information within the image in which the facial images have been extracted. More specifically, the user recognition section 24 extracts information, such as the space between the left and right eyes, a distance from the tip of the nose up to the jaw or the like, as information of a characteristic amount for identifying a facial image, for example, from the extracted facial images, performs recognition based on a combination of these, attaches user IDs (Identifier) which become recognition results, and supplies the attached user IDs to the window management section 25 together with information of the browsing positions.

The window management section 25 causes various types of processes of a display position of the windows and content constituted from software programs managed by the windows to be executed, based on various types of operation signals input by the operation section 22, via the input section 23. Further, the window management section 25 specifies a visual field range on the display section 27, based on information of a browsing position with respect to the display section 27 of a user, changes the size of various types of windows and adjusts and displays a layout, in accordance with the specified visual field range.

When one of the users performs a log out, the window management section 25 converts actual coordinates of the size and layout of windows immediately prior to performing the log out into layout data constituted from relative coordinates, and causes the layout data to be stored in the layout data storage section 26 in association with a user ID. Further, when the user performs a log in, the window management section 25 reads the layout data, based on the user ID. Then, the window management section 25 calculates actual coordinates which specify the size and position of the windows, from the relative coordinates of the read layout data, and specifies and displays the display position to be displayed on the display section 27 based on the calculated actual coordinates.

More specifically, the window management section 25 includes a visual field range specification section 31 and a coordinate calculation section 32. The visual field range specification section 31 specifies a visual field range in the horizontal direction and the vertical direction on the display section 27 of a user, from the browsing position with respect to the display section 27 of the user. The window management section 25 adjusts the size so that windows can be displayed only within the visual field range such as that specified.

When one of the users performs a log out, the coordinate calculation section 32 converts information of actual coordinates of each window intermediately prior to performing the log out into layout data constituted from relative coordinates, based on information of the visual field range of the user, and causes the layout data to be stored in the layout data storage section 26 in association with a user ID. Further, when the user performs a log in, the coordinate calculation section 32 accesses the layout data storage section 26, and retrieves and reads the layout data corresponding to the user ID. In addition, the coordinate calculation section 32 calculates actual coordinates, based on the visual field range at the time when performing a log in of the user and the information constituted from relative coordinates included in the layout data, and causes the windows to be displayed within the visual field range of the display section 27.

### <Log Out Time Process>

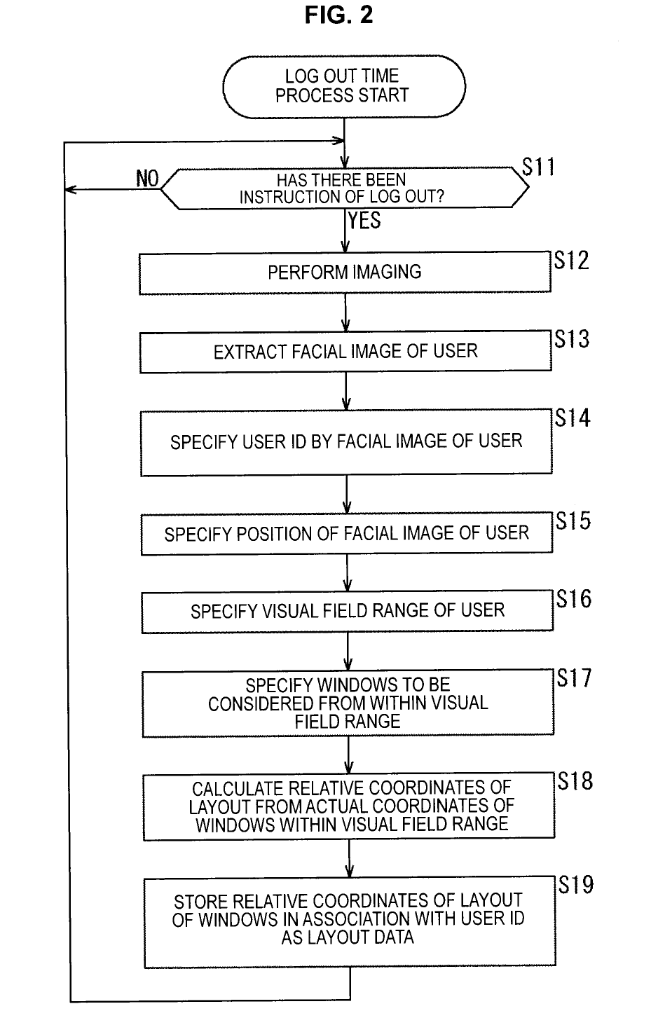

Next, a log out time process will be described with reference to the flow chart of FIG. 2.

In step S11, the window management section 25 determines whether or not a log out has been instructed, by performing an operation by the operation section 22 via the input section 23, and in the case where there is no instruction of a log out, the same process is repeated. For example, in the case where there has been an instruction of a log out in step S11, the process proceeds to step S12.

In step S12, the imaging section 21 captures an image in the vicinity of the front of the display section 27 of a range in which users are present, who are browsing the windows of each content displayed on the display section 27 of the information processing apparatus 11, or who are inputting operations to these windows, and supplies the captured image to the user recognition section 24 via the input section 23.

In step S13, the user recognition section 24 specifies the position of one of the users within the supplied image, based on information of an operation position at which operation information of a log out has been input, and extracts a facial image of the user who has executed an operation of a log out.

In step S14, the user recognition section 24 executes authentication by the extracted facial image, and specifies a user ID. Note that, the user IDs are registered in advance in a database or the like, which is not shown, associated with a characteristic amount of the facial images. Therefore, the user recognition section 24 accesses this database, and specifies the user ID of the user, by reading the corresponding user ID.

In step S15, the user recognition section 24 specifies the position of the facial image of the user, in accordance with a browsing position of the user specified by a direction and distance with respect to the front direction of the display section 27 which becomes a browsing position of the user, and supplies the specified position to the window management section 25 together with the user ID.

In step S16, the window management section 25 causes a visual field range on the display section 27 of the user to be specified, based on information of the supplied user ID and position of the facial image, by controlling the visual field range specification section 31.

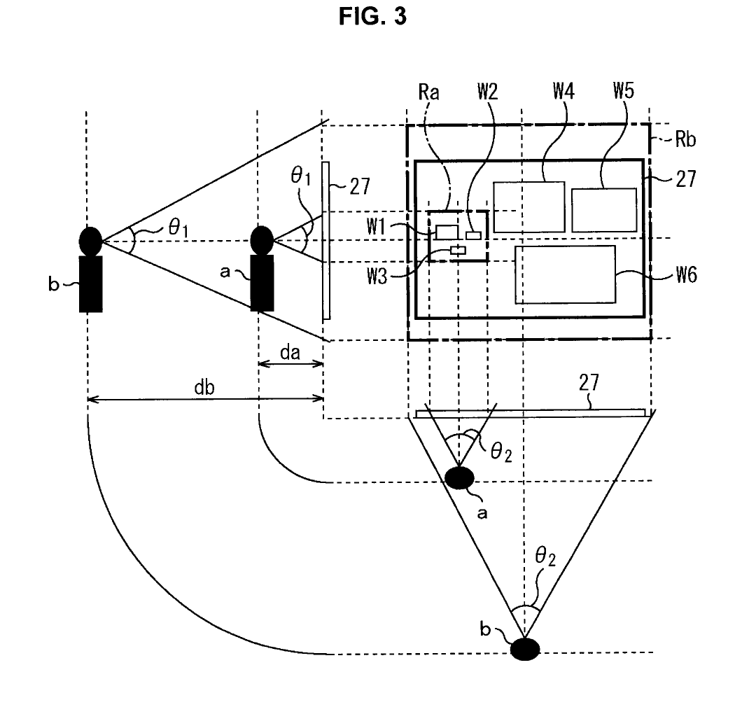

More specifically, the visual field range is calculated by visual field angles in the horizontal direction and the vertical direction. If the visual field angles are constant, the visual field range will be specified by a distance between the display section 27 and a user. That is, as shown in FIG. 3, in the case where the user a is at a distance da from the display section 27, with a visual field angle θ1 in the vertical direction and a visual field angle θ2 in the horizontal direction, the visual field range of the user a will become the visual field range Ra surrounded by a dashed line. Further, the visual field range of the user b, who is present at the position of a distance db from the display section 27, will become the visual field range Rb.

Note that, in FIG. 3, the upper right part within the figure is a front view of the display section 27 shown by a solid line, the lower right part within the figure is an upper view showing the position relation of users a and b with the display section 27, and the upper left part within the figure is a side view showing the position relation of users a and b with the display section 27. Further, in the display section 27 of the upper right part within the figure, the visual field range Ra shown by a dashed line is the visual field range of the user a, and the visual field range Rb is the visual field range of the user b.

In step S17, the window management section 25 specifies the windows to be considered, from within the visual field range, for each of the users.

In FIG. 3, windows W1 through to W3 are displayed within the visual field range Ra of the user a, and windows W 1 through to W6 are displayed within the visual field range Rb of the user b.

That is, in the case of FIG. 3, while the windows WI through to W6 are displayed on the display section 27, only the windows W1 through to W3 within the visual field range Ra can be browsed for the user a. Further, while the user b is able to browse all of the windows W1 through to W6 within the visual field range Rb, there will be cases where browsing is difficult from the browsing position of the user b at a distance db (<da) from the display section 27, even if the windows W1 through to W3 are at a size which is easy to browse for the user a at a distance da closer to the display section 27. The window management section 25 specifies the size of the windows capable of being browsed according to the distance and size, and regards the windows of a distance and size capable of being browsed within these as windows to be considered. In the example of FIG. 3, the windows to be considered for the user b are the windows W4 through to W6.

In step S18, the window management section 25 causes relative coordinates to be calculated, based on actual coordinates of the windows to be considered for each user, by controlling the coordinate calculation section 32, and generates layout data constituted from the relative coordinates.

### <Relative Coordinates>

Here, a calculation method of relative coordinates by the coordinate calculation section 32 will be described.

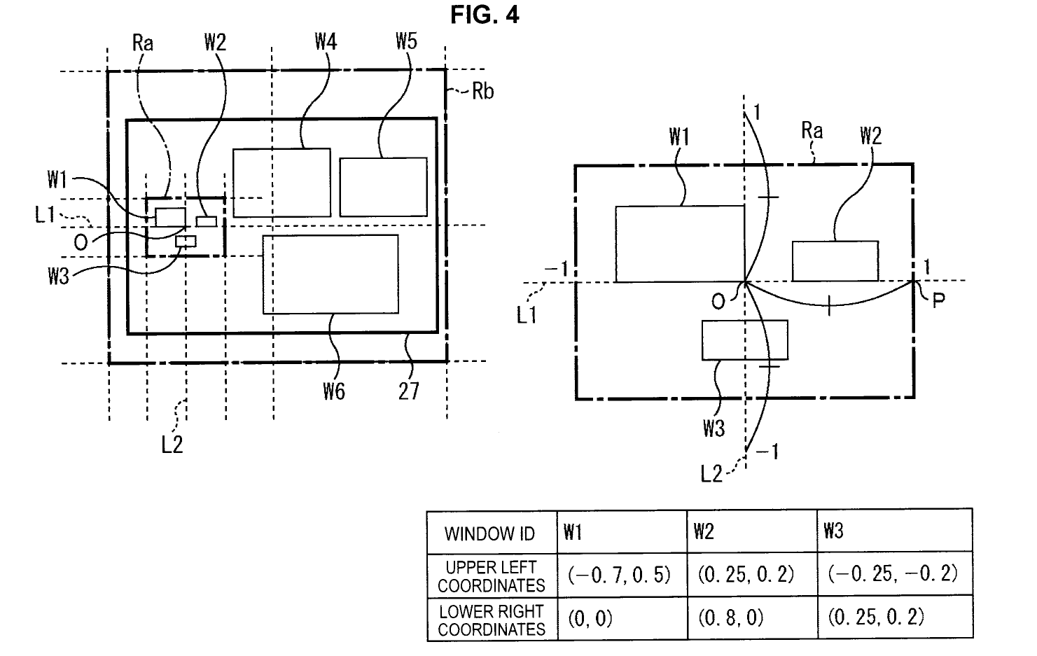

For example, in the case of the visual field range Ra of the user a shown in the upper left part of FIG. 4, the windows to be considered are the windows W 1 through to W3 included in the visual field range Ra. Accordingly, in such a case, the coordinate calculation section 32 sets a central axis L1 in the horizontal direction and a central axis L2 in the vertical direction of the visual field range Ra, based on the actual coordinates, such as shown in the upper right part of FIG. 4, and sets the intersection point of the axes L1 and L2 to an origin point 0. In addition, the coordinate calculation section 32 sets a coordinate system in which the distance from the origin point 0 up to the upper side, the lower side, the left side and the right side of the visual field range Ra is set to 1, and as shown in the lower right part of FIG. 4, sets the upper left coordinates and the lower right coordinates of the windows W1 through to W3 as relative coordinates.

In the lower right part of FIG. 4, for example, the upper left coordinates of the window W1 are set to (−0.7, 0.5), and the lower right coordinates are set to (0, 0).

Further, the upper left coordinates of the window W2 are set to (0.25, 0.2), and the lower right coordinates are set to (0.8, 0). In addition, the upper left coordinates of the window W3 are set to (−0.25, −0.2), and the lower right coordinates are set to (0.25, 0.2).

That is, by having relative coordinates set with respect to the actual coordinates, the upper left coordinates and the lower right coordinates of the window group used by a user are set as coordinates of a coordinate system set with an absolute value 1 in the horizontal direction and the vertical direction, with a central position of the visual field range set to an origin point.

Here, the description will return to that of the flow chart of FIG. 2. In step S19, the window management section 25 causes the layout data constituted from relative coordinates of the window group, which is managed by a user who is performing a log out, converted to relative coordinates calculated by the coordinate calculation section 32, to be stored in the layout data storage section 26 in association with a user ID.

According to the above described processes, when performing a log out, layout data of a window group used by a user is generated, and it becomes possible to store the generated layout data in the layout data storage section 26 in association with a user ID.

### <Log In Time Process>

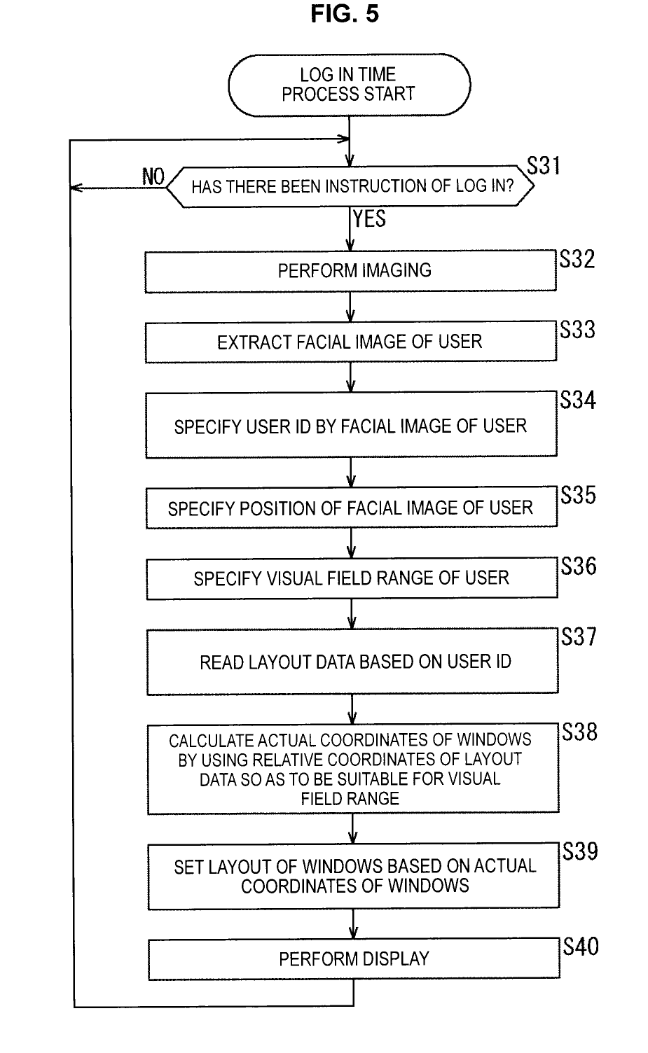

Next, a log in time process will be described with reference to the flow chart of FIG. 5.

In step S31, the window management section 25 determines whether or not a log in has been instructed, by performing an operation by the operation section 22 via the input section 23, and in the case where there is no instruction of a log in, the same process is repeated. For example, in the case where there has been an instruction of a log in in step S31, the process proceeds to step S32.

In step S32, the imaging section 21 captures an image of the range in which users are present, who are browsing the windows of each content displayed on the display section 27 of the information processing apparatus 11, or who are inputting operations to these windows, and supplies the captured image to the user recognition section 24 via the input section 23.

In step S33, the user recognition section 24 specifies and extracts the position of a facial image of one of the users who has executed an operation of a log in, from within the supplied image, based on information of an operation position at which operation information of a log in has been input.

In step S34, the user recognition section 24 extracts a characteristic amount from the extracted facial image, executes authentication based on the characteristic amount, and specifies a user ID from an authentication result.

In step S35, the user recognition section 24 specifies a browsing position of the user in the front direction of the display section 27 which becomes a browsing position of the user, specifies a position of the facial image of the user in the specified browsing position, and supplies the specified position to the window management section 25 together with the user ID.

In step S36, the window management section 25 causes the visual field range on the display section 27 of the user to be specified, based on information of the supplied user ID and position of the facial image, by controlling the visual field range specification section 31.

In step S37, the window management section 25 accesses the layout data storage section 26, and reads the layout data registered in association with the user ID.

In step S38 the window management section 25 causes actual coordinates of the windows to be calculated, by using the relative coordinates of the layout data so as to be suitable for the visual field range of the user who has performed a log in, by controlling the coordinate calculation section 32.

That is, the coordinate calculation section 32 multiplies a coefficient, which becomes a distance from the central position of the visual field range up to the right-most part at the time of performing a log in, by all of the coordinate values in the horizontal direction of the relative coordinates which is the layout data, and multiplies a coefficient, which becomes a distance from the central position of the visual field range up to the upper-most part at the time of performing a log in, by all of the coordinate values in the vertical direction of the relative coordinates. In addition, the coordinate calculation section 32 calculates actual coordinates by causing the coordinate values multiplied by the coefficients to be offset, by an offset between the central position of the visual field range and the central position of the display section 27 at the time of performing a log in.

In step S39, in the case of the user a described with reference to FIG. 3 and FIG. 4, for example, the window management section 25 sets windows W1 through to W3 to a layout in the coordinate positions obtained by the coordinate calculation section 32.

In step S40, the window management section 25 sets the windows W1 through to W3 to the layout such as described above, and causes this layout to be displayed on the display section 27.

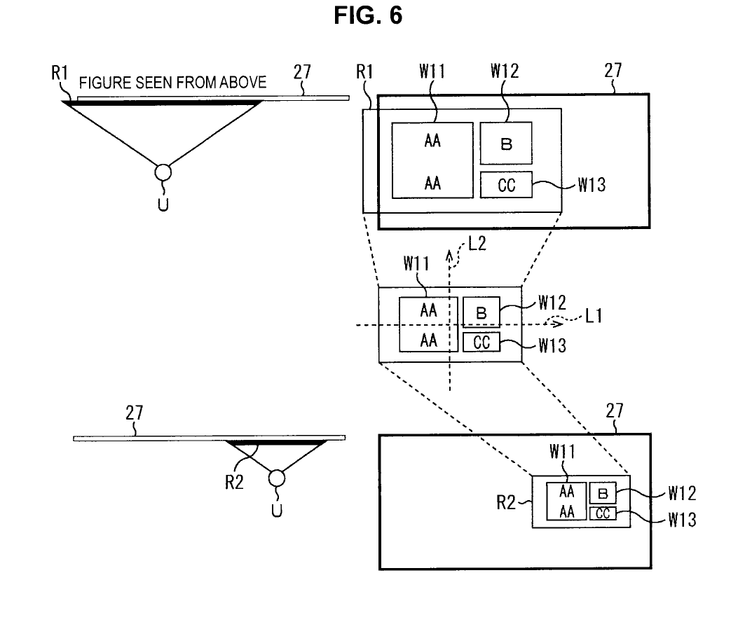

According to the above described processes, for example, it becomes possible to perform processes such as those shown in FIG. 6.

That is, as shown in the upper left stage of FIG. 6, the visual field range on the display section 27 of a user U is the visual field range R1, and when a log out is instructed in a state where the windows W11 through to W13 are present within the visual field range R1, such as shown in the upper right stage of FIG. 6, layout data constituted from relative coordinates, such as that shown in the center right stage of FIG. 6, will be generated.

That is, the layout data expressed by relative coordinates is obtained as relative coordinates which become normalized coordinates within the visual field range of the window group of each of the windows W11 through to W13.

Then, when a user performs a log in in a state of the visual field range R2 (<visual field range R1) such as shown in the lower left stage of FIG. 6, the layout data constituted from relative coordinates obtained as normalized coordinates is enlarged to the actual size of the visual field range, in accordance with the size of the visual field range R2 such as shown in the lower right stage of FIG. 6, and is displayed with the central position offset. As a result of this, since the window group is displayed again with equal proportions and with the same layout within the visual field range, when a log in is performed again, even if a log out is performed while content displayed by a window is being operated, it becomes possible to continue the operation without a sense of discomfort, even if performing a log out once and then performing a log in again.

### <Another Example of Relative Coordinates>

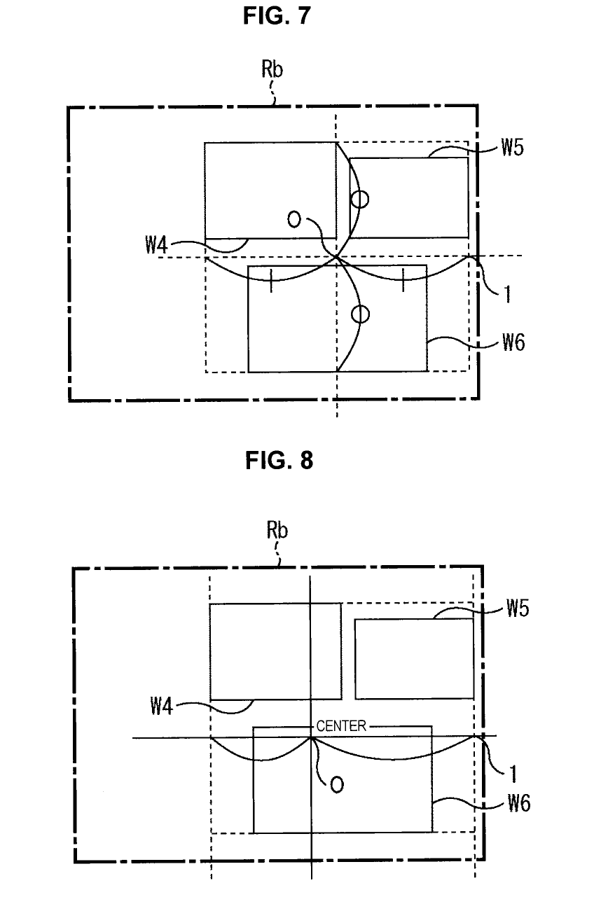

While an example has been described heretofore in which the origin point 0 of the relative coordinates uses the central position within the visual field range, since the upper left coordinates and lower right coordinates of the window group (may be coordinates on a diagonal line) may be obtained, the origin point may be at another position. For example, as shown in FIG. 7, in the case of the visual field range Rb of the user b, a coordinate system may be set, in which the central position of a rectangle constituted from the upper-most part, the lower-most part, the right-most part and the left-most part on the surface occupied by the windows W4 through to W6 is set to the origin point 0. In FIG. 7, the central position in a rectangle constituted by the left part and the upper part of the window W4, the right part of the window W5 and the lower part of the window W6 is set to the origin point 0.

Further, as shown in FIG. 8, area center position of the windows W4 through to W6 may be set to the origin point 0, the position of the part most distant from the origin point 0 in the horizontal position may be set to a coordinate system in which an absolute value becomes 1, and the position of the part most distant from the origin point 0 in the vertical direction may similarly be set to a coordinate system in which an absolute value becomes 1.

### 2. Second Embodiment

### <Configuration Example of the Information Processing System>

While an example has been described heretofore in which a user performs a log in and a log out for the same information processing apparatus, a log in and a log out may be performed between different terminal apparatuses, in an information processing system constituted from different information processing apparatuses or different devices.

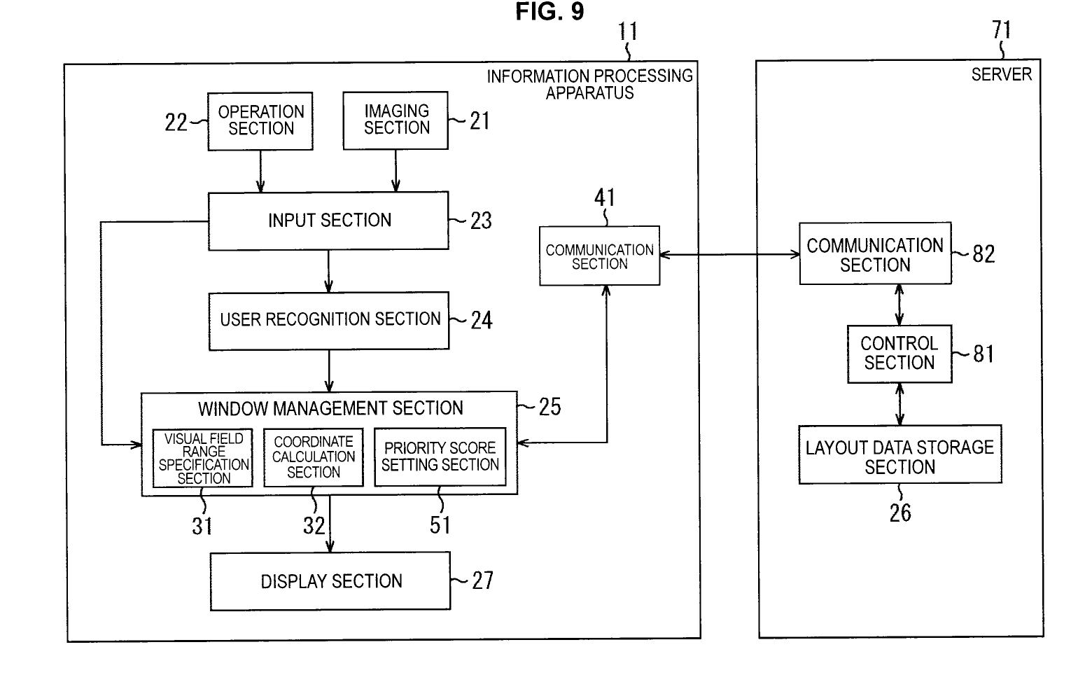

FIG. 9 shows a configuration example of an information processing system constituted by an information processing apparatus and a server. Note that, in FIG. 9, the same reference numerals and names are attached for the configurations which include the same functions as the configurations in FIG. 1, and a description of these will be omitted.

That is, in FIG. 9, the configuration different to FIG. 1 is the point of including a server 71 in addition to the information processing apparatus 11. Further, the information processing apparatus 11 of FIG. 9 includes a communication section 41 instead of the layout data storage section 26 in FIG. 1. Further, the server 71 includes a control section 81, a communication section 82 and a layout data storage section 26. The control section 81 controls all the operations of the server 71. The communication section 82 exchanges data and programs which may be necessary with the communication section 41 of the information processing apparatus 11, via a public network or the like, by performing a control by the control section 81.

That is, the information processing system of FIG. 9 is constituted by having the layout data storage section 26 in the information processing apparatus 11 shifted to the server 71. Accordingly, the information processing apparatus 11 can be assumed to be various types of devices including similar functions, and is not only an information processing apparatus which includes a large-sized display section 27 such as that described above, for example, but may be a personal computer which includes a medium-sized display section 27, a mobile phone device or a portable tablet which includes a small-sized display section 27 or the like.

In this case, when the display section 27 is a small size, it is possible for the device to which a log off is performed to be a device which includes a large-sized display section 27, and the device to which the following log in is performed to be a device only including a small-size display section 27. In such a case, when all of the windows are displayed with the above described technique, there is the possibility that browsing will become difficult due to a very small window size.

Therefore, in the information processing apparatus 11 in FIG. 9, a priority is set for a window group managed by a user, and in the case where the display section 27 is small, only the windows with a high priority are displayed. Accordingly, a priority score setting section 51 is included in the window management section 25 of FIG. 9.

The priority score setting section 51 sets a priority score, based on any of history information (operation frequency) of operations for the windows, the size of the windows, and a frequency of the visual line direction turned toward respective windows based on the visual line direction of a user captured by the imaging section 21.

In such a way, it becomes possible to suitably set and display a layout of windows, in accordance with the size of the display section 27 of the device to which a log in is performed.

### <Log Out Time Process>

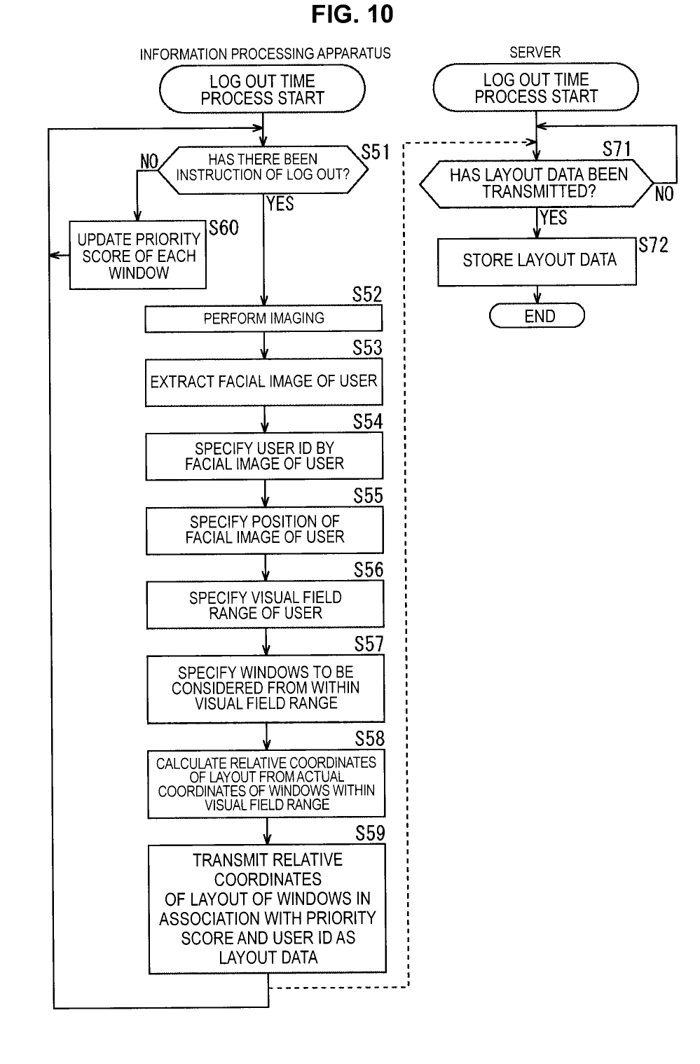

Next, a process at the time of performing a log out in the information processing system of FIG. 9 will be described with reference to the flow chart of FIG. 10. Note that, since the processes of steps S51 through to S58 of the flow chart of FIG. 10 are the same as the processes of steps S11 through to S18 described with reference to the flow chart of FIG. 2, a description of these will be omitted. That is, in the flow chart of FIG. 10, the differences with the flow chart of FIG. 2 are the processes of steps S59, S60, S71 and S72.

That is, in the case where a log out is not instructed in step S51, in step S60, the priority score setting section 51 sets a priority score, by any, or a combination, of history information (operation frequency) of operations for the windows, the size of the windows, and a frequency of the visual line direction turned toward respective windows of a user captured by the imaging section 21. That is, the priority score setting section 51 adds to the priority score, as the operation frequency for each window in a prescribed time interval increases, as the state in which the window size is large continues for a long time, or as the total time at which the visual line is turned toward increases. That is, in the state where a log out is not instructed, the priority score setting section 51 sets a score in accordance with the operation frequency, the size of the windows, the frequency at which the visual line direction is turned toward or a continuous time of this, while the processes of steps S51 and S60 are repeated.

Then, when a log out has been instructed in step S51, and a priority score is obtained, in addition to the relative coordinates by the processes of steps S52 through to S58, in step S59, the window management section 25 generates layout data constituted from the relative coordinates and the priority score, and transmits the generated layout data to the server 71, by controlling the communication section 41, in association with a user ID.

In step S71, the control section 81 of the server 71 determines whether or not the layout data has been transmitted, by controlling the communication section 82, and repeats the same process until the layout data is transmitted. Then, when the layout data has been transmitted by the process of step S59 in step S71, in step S72, the control section 81 receives the layout data by controlling the communication section 82, and causes the received layout data to be stored in the layout data storage section 26.

According to the above described processes, when the process of a log out is performed, layout data in which a priority score has been added to the information of the relative coordinates for each user is transmitted to the server 71, and the transmitted layout data is stored in the layout data storage section 26 of the server 71.

### <Log In Time Process>

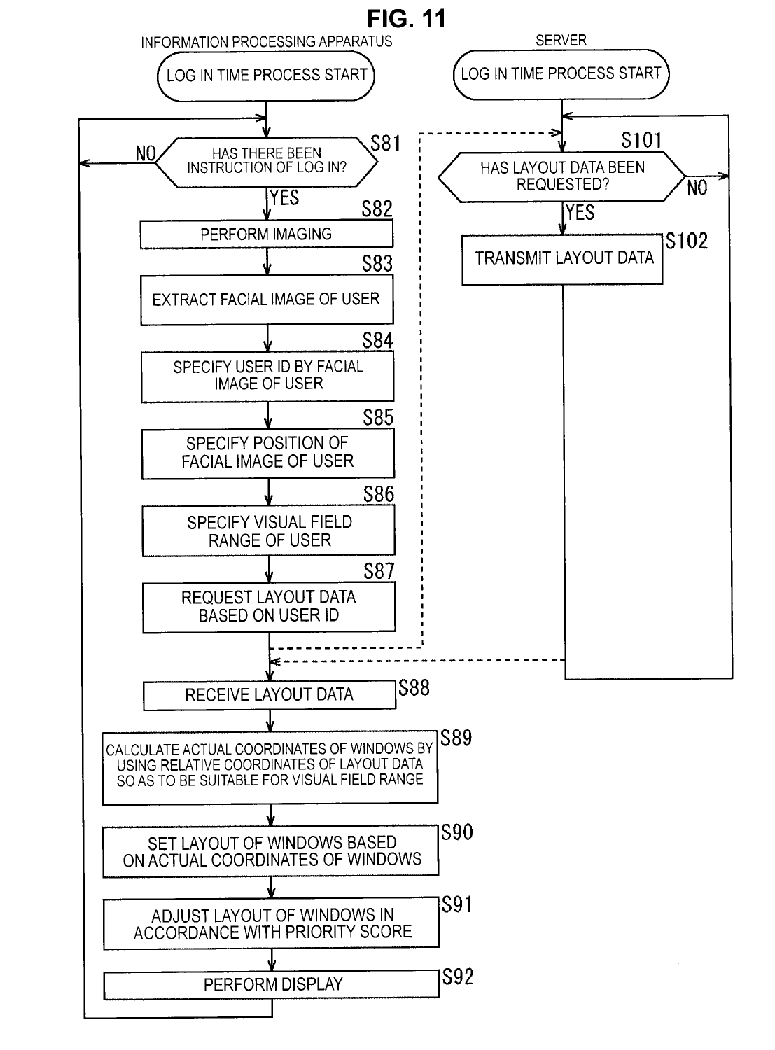

Next, a process at the time of performing a log in by the information processing system of FIG. 9 will be described with reference to the flow chart of FIG. 11. Note that, since the processes of steps 81 through to S86, S89, S90 and S92 in the flow chart of FIG. 11 are the same as the processes of steps S31 through to S36 and S38 through to S40 described with reference to the flow chart of FIG. 5, a description of these will be omitted.

That is, in step S87, the window management section 25 requests layout data, based on a user ID in the server 71 by controlling the communication section 41.

In step S101, the control section 81 of the server 71 determines whether or not layout data has been requested from the information processing apparatus 11 by controlling the communication section 82, and repeats the same process until layout data is requested. Then, in the case where there has been a request of layout data in step S101, the control section 81 reads layout data corresponding to the requested user ID by the layout data storage section 26, and transmits the layout data to the information processing apparatus 11, by controlling the communication section 82.

In step S88, the window management section 25 receives the transmitted layout data, by controlling the communication section 41.

In step S89, the window management section 25 causes actual coordinates to be calculated from the relative coordinates of the window group of the layout data, by controlling the coordinate calculation section 32.

In step S90, the window management section 25 sets the windows to a layout based on the actual coordinates.

In step S91, the window management section 25 adjusts the layout of the windows, based on the priority score associated with the layout data.

In step S92, the window management section 25 causes the window group to be displayed on the display section 27.

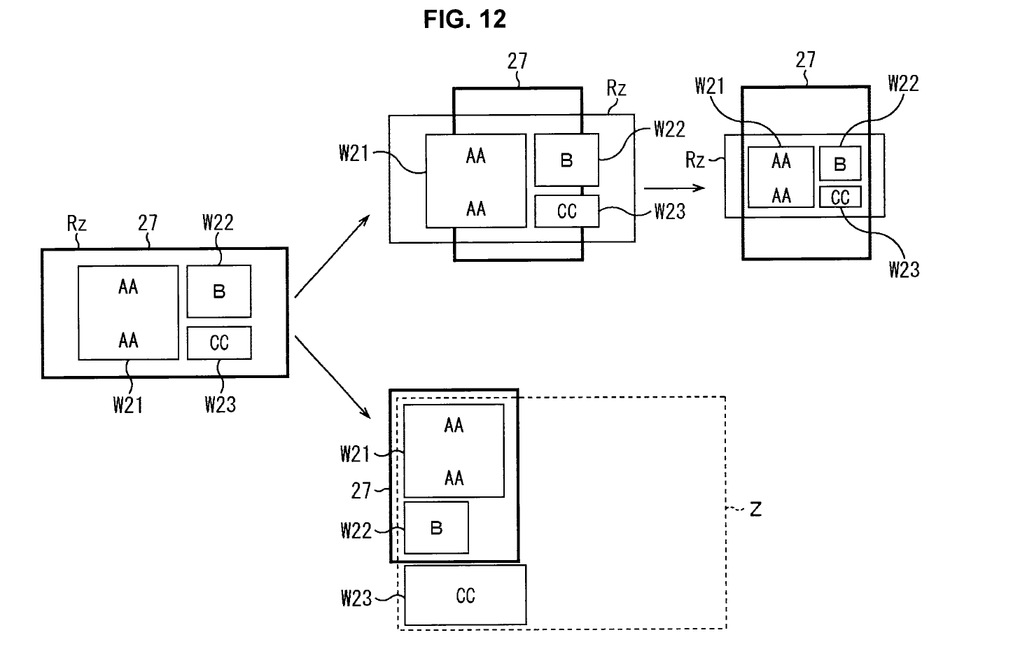

That is, in the case where windows W21 through to W23 are set to a layout with respect to a visual field range Rx such as that shown in the left part of FIG. 12, and in the case where the windows W21 through to W23 are not able to be displayed on the display section 27, such as shown in the upper center part of FIG. 12, the window management section 25 may compress and display the windows such as shown in the upper right part of FIG. 12.

Further, in the case where browsing becomes difficult as it the size decreases when performing a compressed display, the window management section 25 may display the windows on the display section 27 in the order of the highest priority score, such as shown in the lower center part of FIG. 12. That is, in the lower center part of FIG. 12, since the window W21 has the highest priority score, and the next highest priority score is in the window W22, only the windows W21 and W22 are displayed on the display section 27, and the window 23 is not displayed. However, as shown in FIG. 12, a configuration is set, for the window W23 which becomes the next point, which is capable of displaying windows with a low priority score, in which a region Z is set capable of displaying the display on the display section 27 by scrolling, sliding or the like. That is, in the case where browsing becomes difficult when performing a compressed display, the window management section 25 sets a virtual region Z wider than the display section 27, and sets a layout for the window group on this region Z. Then, the window management section 25 causes only the range in which windows are present with a high priority score, from among the windows on this region Z, to be displayed on the display section 27. In this way, it becomes possible to preferentially display windows with a high priority score in accordance with the size of the display section 27. Further, it becomes possible to also display, by scrolling or sliding, windows with a low priority score which are not able to be displayed.

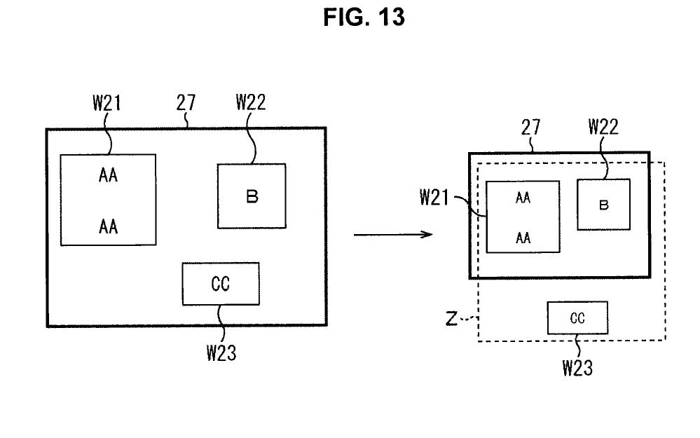

In addition, a suitable size is set for the size of the windows in advance, in accordance with the resolution, or a resolution or size of the display section 27, and at the time when it there is the possibility of being larger or smaller than this suitable size, a display can be performed in a range which can be displayed, upon adjusting to the suitable size from the window with the highest priority score. That is, as shown in the left part of FIG. 13, in the case where windows W21 through to W23 are set to a layout in a visual range Rx at the time of performing a log out, only the windows W21 and W22 with a high priority score may be displayed, in accordance with the size of the display section 27, such as shown in the right part of FIG. 13. However, in this case, a configuration can be set, which is capable of displaying the window W23 with a low priority score, in which a virtual region Z for setting a layout of the window group is set, by scrolling or sliding the display range in the display section 27.

According to the above described processes, in the case where an information processing apparatus to which a log out is performed and an information processing apparatus to which a log in is performed are different, it becomes possible for the layout immediately prior to performing the log out to be restored and displayed if possible, in accordance with the configuration of the display section 27. Further, even if in a state in which the layout is not able to be completely restored, due to the configuration of the display section 27, the windows in which the priority score is high from a ranking of usage frequency are displayed, and it becomes possible to be able to easily perform a display, by scrolling or sliding from the windows to which a priority score applies, even if there are windows which are not able to be displayed.

Incidentally, the above series of processes can, for example, be executed by hardware, or can be executed by software. In the case where the series of processes is executed by software, a program configuring this software is installed in a computer included in dedicated hardware, or a general-purpose personal computer which can execute various functions when various programs are installed, etc., from a recording medium.

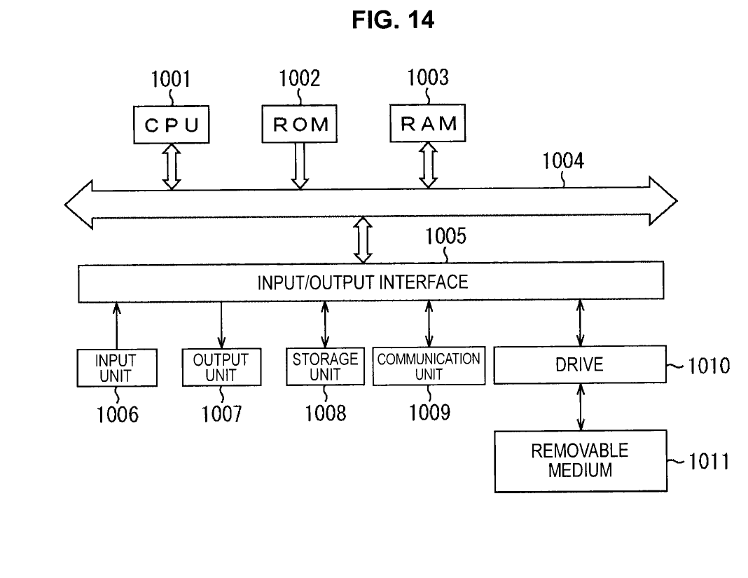

FIG. 14 shows an example configuration of a general-purpose personal computer. The computer includes a CPU (Central Processing Unit) 1001. An input/output interface 1005 is connected to the CPU 1001 through a bus 1004. A ROM (Read Only Memory) 1002 and a RAM (Random Access Memory) 1003 are connected to the bus 1004.

An input unit 1006 including an input device, such as a keyboard, a mouse, etc., which is used by the user to input an operation command, an output unit 1007 which outputs a process operation screen or an image of a process result to a display device, a storage unit 1008 including a hard disk drive etc. which stores a program or various items of data, and a communication unit 1009 including a LAN (Local Area Network) adaptor etc. which performs a communication process through a network typified by the Internet, are connected to the input/output interface 1005. Also, connected is a drive 1010 which reads and writes data from and to a removable medium 1011, such as a magnetic disk (including a flexible disk), an optical disk (including a CD-ROM (Compact Disc-Read Only Memory) and a DVD (Digital Versatile Disc)), an magneto-optical disk (including an MD (Mini Disc)), or a semiconductor memory, etc.

The CPU 1001 executes various processes according to a program stored in the ROM 1002 or a program which is read from the removable medium 1011, such as a magnetic disk, an optical disk, a magneto-optical disk, or a semiconductor memory, etc., is installed in the storage unit 1008, and is loaded from the storage unit 1008 to the RAM 1003. The RAM 1003 also stores data which is requested when the CPU 1001 executes various processes, etc., as appropriate.

In the computer configured as described above, the CPU 1001 loads a program that is stored, for example, in the storage unit 1008 onto the RAM 1003 via the input/output interface 1005 and the bus 1004, and executes the program. Thus, the above-described series of processing is performed.

Programs to be executed by the computer (the CPU 1001) are provided being recorded in the removable medium 1011 which is a packaged medium or the like. Also, programs may be provided via a wired or wireless transmission medium, such as a local area network, the Internet or digital satellite broadcasting.

In the computer, by inserting the removable medium 1011 into the drive 1010, the program can be installed in the storage unit 1008 via the input/output interface 1005. Further, the program can be received by the communication unit 1009 via a wired or wireless transmission medium and installed in the storage unit 1008. Moreover, the program can be installed in advance in the ROM 1002 or the storage unit 1008.

It should be noted that the program executed by a computer may be a program that is processed in time series according to the sequence described in this specification or a program that is processed in parallel or at necessary timing such as upon calling.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

An embodiment of the disclosure is not limited to the embodiments described above, and various changes and modifications may be made without departing from the scope of the disclosure.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a display section which displays a window for each content including an application program used for each user;

a user recognition section which individually recognizes users browsing the display section; and

a window management section which, at the time when one of the users performs a log out, stores a layout displayed by the display section of a window group used by the user, and at the time when the user performs a log in, causes the window group used by the user to be displayed on the display section by restoring the layout.

(2) The information processing apparatus according to (1),

wherein the window management section includes a visual field range specification section which specifies a visual field range on the display section of the user, and

wherein the window management section, at the time when the user performs a log out, stores a layout displayed on the display section of a window group in a visual field range of the user, and at the time when the user performs a log in, causes windows used by the user to be displayed by restoring the layout in the visual field range of the user.

(3) The information processing apparatus according to (2),

wherein the window management section includes a coordinate calculation section which calculates relative coordinates expressed by a coordinate system set in the visual field range based on actual coordinates of a window group on the display section, or calculates the actual coordinates of a window group on the display section based on the relative coordinates and the visual field range, and

wherein the window management section, at the time when the user performs a log out, causes layout data including the relative coordinates corresponding to actual coordinates of a layout displayed on the display section of the window group in a visual field range of the user to be stored, and at the time when the user performs a log in, reads the layout data, and causes a window group used by the user to be displayed with the actual coordinates, corresponding to the relative coordinates and the visual field range, by restoring the layout in the visual field range of the user.

(4) The information processing apparatus according to (3), further including:

a layout data storage section which stores the layout data,

wherein the window management section, when a log out is performed, causes the layout data to be stored in the layout data storage section together with information identifying the user, and at the time when a log in is performed, reads the layout data from the layout data storage section.

(5) The information processing apparatus according to (4),

wherein the layout data storage section is provided in a server capable of communicating via a network, and

wherein, at the time when the user performs a log out, the window management section causes the layout data to be stored in the layout data storage section of the server, and at the time when the user performs a log in, the window management section reads the layout data from the server, and causes windows used by the user to be displayed on the display section by restoring the layout data.

(6) The information processing apparatus according to (5), further including:

a priority score setting section which sets a priority score for each of the windows in the window group,

wherein, in the case where an information processing apparatus to which the user has performed a log out and an information processing apparatus to which the user has performed a log in are different, the window management section, at the time when all the windows for restoring the layout are not able to de displayed, causes part of the windows to be displayed on the display section in accordance with the priority score.

(7) The information processing apparatus according to (6),

wherein the priority score setting section sets a priority score in accordance with all, or a combination, of an operation history, a display size, and a frequency at which a visual line of the user turns toward, for each of the windows in the window group.

(8) The information processing apparatus according to (6),

wherein, in the case where an information processing apparatus to which the user has performed a log out and an information processing apparatus to which the user has performed a log in are different, the window management section sets a suitable size of windows in accordance with a resolution and size of the display section of the information processing apparatus to which a log in is performed, and at the time when a size of the windows for restoring the layout is larger or smaller than a suitable size, causes the windows to be displayed on the display section by setting to the suitable size.

(9) An information processing method including:

displaying, by a display section, a window for each content including an application program used for each user;

individually recognizing users browsing the display section; and

storing, at the time when one of the users performs a log out, a layout displayed by the display section of a window group used by the user, and at the time when the user performs a log in, causing the window group used by the user to be displayed on the display section by restoring the layout.

(10) A program for causing a computer to execute the processes of:

displaying, by a display section, a window for each content including an application program used for each user;

individually recognizing users browsing the display section; and

storing, at the time when one of the users performs a log out, a layout displayed by the display section of a window group used by the user, and at the time when the user performs a log in, causing the window group used by the user to be displayed on the display section by restoring the layout.

(11) A recording medium a program recorded thereon, the program causing a computer to execute the processes of:

displaying, by a display section, a window for each content including an application program used for each user;

individually recognizing users browsing the display section; and

storing, at the time when one of the users performs a log out, a layout displayed by the display section of a window group used by the user, and at the time when the user performs a log in, causing the window group used by the user to be displayed on the display section by restoring the layout.

(12) An information processing system including:

an information processing apparatus; and

a server,

wherein the information processing apparatus includes

a display section which displays a window for each content including an application program used for each user,

a user recognition section which individually recognizes users browsing the display section, and

a window management section which, at the time when one of the users performs a log out, transmits layout data which is data of a layout displayed by the display section of a window group used by the user to the server, and at the time when the user performs a log in, receives the layout data from the server, and causes the window group used by the user to be displayed on the display section by restoring the layout, and

wherein the server includes

a storage section which stores the layout data, and

a communication section which receives the layout data from the information processing apparatus, and transmits the layout data stored in the storage section to the information processing apparatus.

What is claimed is:

1. An information processing apparatus comprising:
a display section which displays a window for each content including an application program used for each user;
a user recognition section which individually recognizes users browsing the display section; and
a window management section which, at the time when one of the users performs a log out, stores a layout displayed by the display section of a window group used by the user, and at the time when the user performs a log in, causes the window group used by the user to be displayed on the display section by restoring the layout.

2. The information processing apparatus according to claim 1,
wherein the window management section includes a visual field range specification section which specifies a visual field range on the display section of the user, and
wherein the window management section, at the time when the user performs a log out, stores a layout displayed on the display section of a window group in a visual field range of the user, and at the time when the user performs a log in, causes windows used by the user to be displayed by restoring the layout in the visual field range of the user.

3. The information processing apparatus according to claim 2,
wherein the window management section includes a coordinate calculation section which calculates relative coordinates expressed by a coordinate system set in the visual field range based on actual coordinates of a window group on the display section, or calculates the actual coordinates of a window group on the display section based on the relative coordinates and the visual field range, and
wherein the window management section, at the time when the user performs a log out, causes layout data including the relative coordinates corresponding to actual coordinates of a layout displayed on the display section of the window group in a visual field range of the user to be stored, and at the time when the user performs a log in, reads the layout data, and causes a window group used by the user to be displayed with the actual coordinates, corresponding to the relative coordinates and the visual field range, by restoring the layout in the visual field range of the user.

4. The information processing apparatus according to claim 3, further comprising:
a layout data storage section which stores the layout data,
wherein the window management section, when a log out is performed, causes the layout data to be stored in the layout data storage section together with information identifying the user, and at the time when a log in is performed, reads the layout data from the layout data storage section.

5. The information processing apparatus according to claim 4,
wherein the layout data storage section is provided in a server capable of communicating via a network, and
wherein, at the time when the user performs a log out, the window management section causes the layout data to be stored in the layout data storage section of the server, and at the time when the user performs a log in, the window management section reads the layout data from the server, and causes windows used by the user to be displayed on the display section by restoring the layout data.

6. The information processing apparatus according to claim 5, further comprising:
a priority score setting section which sets a priority score for each of the windows in the window group,
wherein, in the case where an information processing apparatus to which the user has performed a log out and an information processing apparatus to which the user has performed a log in are different, the window management section, at the time when all the windows for restoring the layout are not able to de displayed, causes part of the windows to be displayed on the display section in accordance with the priority score.

7. The information processing apparatus according to claim 6,
wherein the priority score setting section sets a priority score in accordance with all, or a combination, of an operation history, a display size, and a frequency at which a visual line of the user turns toward, for each of the windows in the window group.

8. The information processing apparatus according to claim 6,
wherein, in the case where an information processing apparatus to which the user has performed a log out and an information processing apparatus to which the user has performed a log in are different, the window management section sets a suitable size of windows in accordance with a resolution and size of the display section of the information processing apparatus to which a log in is performed, and at the time when a size of the windows for restoring the layout is larger or smaller than a suitable size, causes the windows to be displayed on the display section by setting to the suitable size.

9. An information processing method comprising:
displaying, by a display section, a window for each content including an application program used for each user;
individually recognizing users browsing the display section; and
storing, at the time when one of the users performs a log out, a layout displayed by the display section of a window group used by the user, and at the time when the user performs a log in, causing the window group used by the user to be displayed on the display section by restoring the layout.

10. A program for causing a computer to execute the processes of:
displaying, by a display section, a window for each content including an application program used for each user;
individually recognizing users browsing the display section; and
storing, at the time when one of the users performs a log out, a layout displayed by the display section of a window group used by the user, and at the time when the user performs a log in, causing the window group used by the user to be displayed on the display section by restoring the layout.

11. An information processing system comprising:
an information processing apparatus; and
a server,
wherein the information processing apparatus includes
a display section which displays a window for each content including an application program used for each user,
a user recognition section which individually recognizes users browsing the display section, and
a window management section which, at the time when one of the users performs a log out, transmits layout data which is data of a layout displayed by the display section of a window group used by the user to the server, and at the time when the user performs a log in, receives the layout data from the server, and causes the window group used by the user to be displayed on the display section by restoring the layout, and
wherein the server includes
a storage section which stores the layout data, and
a communication section which receives the layout data from the information processing apparatus, and transmits the layout data stored in the storage section to the information processing apparatus.
